(19) United States
(12) Patent Application Publication
(10) Pub. No.: US 2025/0311759 A1
(43) Pub. Date: Oct. 9, 2025

(54) ORGANIC COMPOUNDS

(71) Applicant: GIVAUDAN SA, VERNIER (CH)

(72) Inventors: Andrew DANIHER, Cincinnati, OH (US); Stephan HAIBER, Naarden (NL); Luis IBANEZ GONZALEZ, Kemptthal (CH); Eric KOHLEN, Naarden (NL); Cornelis WINKEL, Naarden (NL)

(21) Appl. No.: 18/860,393

(22) PCT Filed: Apr. 26, 2023
(86) PCT No.: PCT/EP2023/060956

§ 371 Date: Oct. 25, 2024

Related U.S. Application Data
(60) Provisional application No. 63/335,291, filed on Apr. 27, 2022.

(51) Int. Cl. A23L 27/20; A23L 27/00

(52) U.S. Cl. CPC A23L 27/2054; A23L 27/84; A23L 27/86; A23L 27/88

(57) ABSTRACT

The disclosure relates to the use of compounds of formula (I)

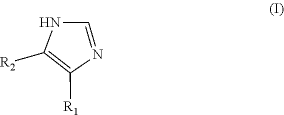

and edible salts thereof, wherein
R₁ and R₂ is independently selected from the group consisting of H, linear C1-C18 hydrocarbon groups, and branched C1-C18 hydrocarbon groups, wherein the C1-C18 hydrocarbon groups bear up to 3 O atoms and/or bear up to one double bond, and/or bear up to one ring,
or wherein R₁ and R₂ form together with the carbon atoms they are attached to an aromatic six membered hydrocarbon ring,
as a flavor modulating compound, and to flavor compositions and consumer products comprising said compounds.

### TECHNICAL FIELD

The present invention relates generally to the use of compounds and edible salts thereof as flavor modulating compounds. The invention further relates to flavor compositions and consumer products like foodstuffs or beverages comprising said compounds. The invention also relates to a method to confer, enhance, improve, complement or modify the flavor properties of a flavor composition or a consumer product by using said compounds.

### BACKGROUND

Saltiness is one of the five basic taste attributes next to umami, sweet, bitter and sour. Salty taste is associated with sodium chloride and is essential to stimulate the uptake of healthy minerals by food. However, modern diets are rich in strongly processed foods which often contain very high amounts of sodium chloride. According to the World Health Organization (WHO) an average daily intake of 5 g/day is recommended. According to the FDA the personal average daily intake (PADI) of sodium chloride for an American is more than 8g sodium chloride per day, which is clearly above the recommended value. Continuously high PADI of sodium chloride can cause negative side effects like hypertension, cardiovascular disease, kidney failure and stroke. It is highly desirable to reduce the PADI of sodium chloride, preferably without compromising the desired salty taste. Therefore, there is a need for compounds which enhance the salty taste perception.

A range of candidate flavor compounds for salt enhancement have been described in literature. For example, in U.S. Pat. No. 9,155,329 B2 low molecular weight amides with additional hydroxyl or alkoxyl groups are disclosed to have salt enhancing properties.

The at least partial replacement of sodium chloride by other salts like potassium chloride is often associated with negative taste aspects (Khetra et al, Int. Dairy J. (2019), 91, 165-171).

Another relevant aspect that is sometimes mixed up with salt perception is umami taste, although completely different receptor mechanisms are involved. The most prominent example for compounds imparting umami taste is monosodium glutamate (MSG) (Ikeda, J. Tokyo Chem. Soc. (1909), 30, 820-836). Umami taste can be modified by the ribonucleotides inosine monophosphate (IMP) and guanosine monophosphate (GMP) (Kodama, J. Chem. Soc. of Japan. (1913), 34:751-757; Kuninaka, J. Agric. Chem. Soc. Jpn. (1960), 34, 487-492). Other compounds which enhance umami taste are for example theanine (Suzuku et al. J Agric Food Chem. (2002), 50 313-318) or a special oligopeptide (Yamasaki, et al, Agric. Biol. Chem. (1978), 42, 1761-1765; Tamura et al, Agric. Biol. Chem. (1989), 53, 319-325).

Glutathione is described to influence umami and saltiness at the same time, more precisely the duration of the taste stimulus (Tazuko et al, Chem. Senses (2016), Volume 41, 623-630). A group of general taste enhancers was reported in EP1291342.

A variety of other molecules is known to improve or to influence salt perception. Also volatile aroma compounds can help to mimic an increased saltiness (Batenburg et al, J. Food Sci. (2011), 76, 280-288).

There remains a need for new taste improving substances to be added to flavorist's palette which can modulate flavor.

### SUMMARY

In accordance with a first aspect of the present invention there is provided the use of a compound of formula (I)

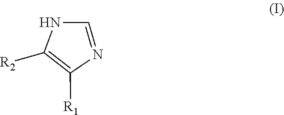

wherein R₁ and R₂ is independently selected from the group consisting of H, linear C1-C18 hydrocarbon groups, and branched C1-C18 hydrocarbon groups, wherein the C1-C18 hydrocarbon groups bear up to 3 O atoms and/or bear up to one double bond, and/or bear up to one ring, or wherein R₁ and R₂ form together with the carbon atoms they are attached to an aromatic six membered hydrocarbon ring,
or an edible salt thereof as a flavor modulating compound.

In accordance with a second aspect of the present invention there is provided a flavor composition comprising a compound of formula (I)

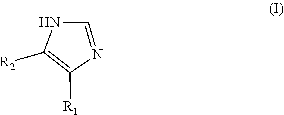

wherein R₁ and R₂ is independently selected from the group consisting of H, linear C1-C18 hydrocarbon groups, and branched C1-C18 hydrocarbon groups, wherein the C1-C18 hydrocarbon groups bear up to 3 O atoms and/or bear up to one double bond, and/or bear up to one ring, or wherein R₁ and R₂ form together with the carbon atoms they are attached to an aromatic six membered hydrocarbon ring,
or an edible salt thereof.

In accordance with a third aspect of the present invention there is provided a consumer product comprising a compound of formula (I)

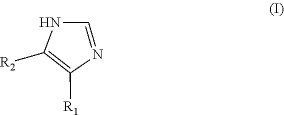

wherein R₁ and R₂ is independently selected from the group consisting of H, linear C1-C18 hydrocarbon groups, and branched C1-C18 hydrocarbon groups, wherein the C1-C18 hydrocarbon groups bear up to 3 O atoms and/or bear up to one double bond, and/or bear up to one ring, or wherein R₁ and R₂ form together with the carbon atoms they are attached to an aromatic six membered hydrocarbon ring,
or an edible salt thereof, or a flavor composition comprising a compound of formula (I) or an edible salt thereof.

In accordance with a fourth aspect of the present invention there is provided a method to confer, enhance, improve or modify the flavor properties of a flavor composition or a consumer product, the method comprising adding to a flavor composition or to a consumer product an amount of a compound of formula (I)

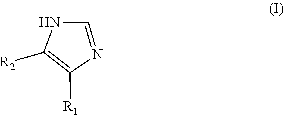

wherein R₁ and R₂ is independently selected from the group consisting of H, linear C1-C18 hydrocarbon groups, and branched C1-C18 hydrocarbon groups, wherein the C1-C18 hydrocarbon groups bear up to 3 O atoms and/or bear up to one double bond, and/or bear up to one ring, or wherein R₁ and R₂ form together with the carbon atoms they are attached to an aromatic six membered hydrocarbon ring,
or an edible salt thereof, sufficient to confer, enhance, improve or modify the flavor properties of a flavor composition or a consumer product.

Certain embodiments of any aspect of the present invention may provide one or more of the following advantages:
modulation, in particular positive modulation, of salty taste perception,
reduction of bitter taste, for example of KCl,
enhanced perception of umami taste,
modulation of acidity, and
enhanced aroma perception of foodstuffs or beverages, in particular of savory foodstuffs or beverages.

The details, examples and preferences provided in relation to any particular one or more of the stated aspects of the present invention will be further described herein and apply equally to all aspects of the present invention. Any combination of the embodiments, examples and preferences described herein in all possible variations thereof is encompassed by the present invention unless otherwise indicated herein, or otherwise clearly contradicted by context.

### DETAILED DESCRIPTION

The present invention is based on the surprising finding that 1H-imidazole and certain derivatives of it have flavor modulating properties.

There is therefore provided a use of one or more compounds of formula (I)

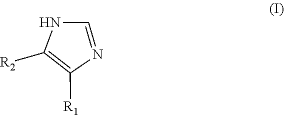

and edible salts thereof,
wherein R₁ and R₂ is independently selected from the group consisting of H, linear C1-C18 hydrocarbon groups, and branched C1-C18 hydrocarbon groups, wherein the C1-C18 hydrocarbon groups bear up to 3 O atoms and/or bear up to one double bond, and/or bear up to one ring, or wherein R₁ and R₂ form together with the carbon atoms they are attached to an aromatic six membered hydrocarbon ring,
as a flavor modulating compound.

For example, the C1-C18 hydrocarbon group can be linear or branched C1-C18 alkyl, linear or branched C2-C18 alkenyl, or formyl.

For example, said C1-C18 alkyl can be Me, Et, n-Pr, iso-Pr, n-Bu, iso-Bu, sec-Bu, tert-Bu, hexadecyl, octadecyl.

For example, said C2-C18 alkenyl can be ethenyl, propenyl, octadecenyl.

For example, said C1-C18 hydrocarbon group can bear up to 3 O atoms, which means 1, 2 or 3 O atoms. For example, said hydrocarbon group bears a hydroxy-, ether-, carbonyl-, carboxyl- and/or ether group.

For example, said C1-C18 hydrocarbon group can bear up to one ring, for example a cyclopentyl, cyclohexyl, cyclopentenyl or cyclohexenyl. Optionally the ring can contain an O atom and/or be substituted with a functional group bearing an O atom. For example, said C1-C18 hydrocarbon group bearing up to 3 O atoms and up to one double bond can be 2-oxoethyl, 3-oxopropyl, carboxyl, carboxymethyl, carboxy(hydroxy)methyl, carboxycarbonyl, 2-carboxyethyl, 2-carboxyvinyl, 3-carboxypropyl. Said substituted alkyl or alkenyl residues are formally derived from acetaldehyde, propanal, formic acid, acetic acid, lactic acid, pyruvic acid, propanoic acid, propenoic acid, butanoic acid, respectively.

The compound of formula (I) wherein R1 and R2 form together with the carbon atoms they are attached to an aromatic six membered hydrocarbon ring is benzimidazole (1H-1,3-Benzimidazole, CAS-No. 51-17-2).

According to certain illustrative embodiments, the formyl residue is formally derived from formaldehyde.

As used herein, edible salts include those typically employed in the food and beverage industry and include chlorides, sulphates, phosphates, gluconates, sodium, citrates, carbonates, acetates, lactates and combinations thereof.

If the compound of formula (I) contains stereo centers or double bonds, the compound is a single isomer, for example an enantiomer or a diastereomer or double bond isomer, or a mixture of more than one isomer. In particular, the double bond of the compounds of formula (I) can have either E- or Z-configuration, or the compound is present as a mixture. The stereo center of the compounds of formula (I) can have either R- or S-configuration, or the compound is present as a mixture.

1H-Imidazole exists in two equivalent tautomeric forms, and both tautomeric forms are encompassed by the present invention. For example, 4-methyl-1H-imidazole is the tautomer of 5-methyl-1H-imidazole.

Furthermore, the compound of the invention may be a mixture of more than one chemical compound in the form of any one of its isomers or a mixture thereof.

The compounds of the present invention described above possess flavor modulating properties. For example, some of the compounds can enhance the salty taste perception, and/or reduce bitter taste, and/or modulate acidity and freshness and/or enhance umami taste.

Throughout this document the terms “taste” and “flavor” are used interchangeably to describe the sensory impact that is perceived via the mouth, especially the tongue, and the olfactory epithelium in the nasal cavity.

As used herein, the term “flavor modulating compound” refers to a compound that has weak or hardly noticeable flavor properties on its own in the employed concentrations. However, said compound is capable of altering or complementing or modulating or contributing to the taste impact of other flavoring substances contained in a flavor composition or in a consumer product, including the salty taste impact, acidic taste impact, bitterness and/or umami taste impact.

For example, the flavor modulating compound does not have any salty taste at all below 40 ppm. The compound might have a slightly salty taste at a level between 50 ppm and 100 ppm. At higher levels, for example at about 1000 ppm, the compound might still have only a weak salty taste. In combination with salty flavor compounds, for example with NaCl, it can enhance the salty taste perception.

For example, the flavor modulating compound does not have any recognizable taste at a level below 40 ppm for counteracting or masking bitter taste. At higher levels, for example at about 1000 ppm, the compound might even have a strong bitter taste. In combination with compounds which can have bitter off taste, for example KCl, the compound can reduce bitter taste for example, when employed at a level between 50 ppm and 100 ppm.

For example, the flavor modulating compound does not impart any umami taste at a level below 40 ppm. In combination with compounds which can impart umami taste, for example MSG, the umami taste is enhanced, for example, when employed at a level between 50 ppm and 100 ppm.

For example, the flavor modulating compound might impact the acidity and freshness.

As used herein, the term “flavoring substance” refers to any substance that is capable of imparting a detectable flavor impact, preferably at a concentration below 0.1 wt. %, more preferably below 0.01 wt. %. For example, such flavoring substance may be selected from natural flavors, artificial flavors, spices, seasonings, and the like, synthetic flavor oils and flavor aromatics and/or oils, oleoresins, essences, distillates, and extracts derived from plants, leaves, flowers, fruits, and so forth, Generally, any flavor or food additive such as those described in Chemicals Used in Food Processing, publication 1274, pages 63-258, by the National Academy of Sciences, can be used. This publication is incorporated herein by reference.

It was found that the flavor modulating compounds of the invention are very useful ingredients which are capable in the presence of other flavoring substances to impart highly appreciated taste sensations to the products in which they are incorporated, specifically “roundness”, “fullness”, “substance”, “transparency”, “complexity”, “expanding”, “continuity”, “long lasting”, “tingling”, “numbing”, “bitter” and/or “metallic”. Because of this, the present taste improving substances can be employed to improve the taste (including “mouthfeel”) of foodstuffs and beverages.

In one embodiment of the present invention, there is provided the use of the compound according to formula (I) and edible salts thereof, as a flavor modulating compound,

wherein one of R₁ and R₂ is H,
and the other one of R₁ and R₂ is selected from the group consisting of linear or branched C1-C18 hydrocarbon groups, bearing up to 3 O atoms and/or bearing up to one double bond, and/or bearing up to one ring,
or wherein R₁ and R₂ form together with the carbon atoms they are attached to an aromatic six membered hydrocarbon ring.

In one embodiment of the present invention, there is provided the use of the compound according to formula (I) and edible salts thereof, as a flavor modulating compound,

wherein one of R₁ and R₂ is H,
and the other one of R₁ and R₂ is selected from the group consisting of Me, Et, n-Pr, iso-Pr, n-Bu, iso-Bu, sec-Bu, tert-Bu, hexadecyl, octadecyl, ethenyl, propenyl, octadecenyl, formyl, 2-oxoethyl, 3-oxopropyl, carboxyl, carboxymethyl, carboxy(hydroxy)methyl, carboxycarbonyl, 2-carboxyethyl, 2-carboxyvinyl and 3-carboxypropyl,
or wherein R₁ and R₂ form together with the carbon atoms they are attached to an aromatic six membered hydrocarbon ring.

In one embodiment of the present invention, there is provided the use of the compound according to formula (I) as defined above and edible salts thereof, as flavor modulating compound, wherein the compound of formula (I) is selected from the group consisting of 1H-imidazole, 4-methyl-1H-imidazole, 4-ethyl-1H-imidazole, 4-propyl-1H-imidazole, 4-butyl-1H-imidazole, 4-hexadecyl-1H-imidazole, 4-octadecyl-1H-imidazole, 4-ethenyl-1H-imidazole, 4-propenyl-1H-imidazole, 4-octadecenyl-1H-imidazole, 1H-imidazole-4-carbaldehyde, 2-(1H-imidazol-4-yl)acetaldehyde, 3-(1H-imidazol-4-yl)propanal, 1H-imidazole-4-carboxylic acid, 2-(1H-imidazol-4-yl)acetic acid, 2-hydroxy-2-(1H-imidazol-4-yl)acetic acid, 2-(1H-imidazol-4-yl)-2-oxoacetic acid, 3-(1H-imidazol-4-yl)propanoic acid, 3-(1H-imidazol-4-yl)acrylic acid (urocanic acid), 4-(1H-imidazol-4-yl)butanoic acid and benzimidazole.

In particular, there is provided the use of a compound according to formula (I), wherein the compound of formula (I) is selected from the group consisting of 1H-imidazole, 4-methyl-1H-imidazole, 3-(1H-imidazol-4-yl)acrylic acid (urocanic acid), 2-(1H-imidazol-4-yl)acetic acid, and benzimidazole.

1H-imidazole is a well-known compound, and an important structural element in pharmaceutical and agrochemical compounds. So far, no taste or taste modulating properties have been reported in literature. 4-methyl-1H-imidazole is present in caramel color that is widely used in foodstuff and beverages. However, there is no information about taste or taste modulating properties of said compound available. 3-(1H-imidazol-4-yl)acrylic acid (urocanic acid) is a compound known in the field of skin care. Benzimidazole is a known starting material for the synthesis of many drugs.

In a further embodiment of the present invention, there is provided the use of a mixture of two or more compounds according to formula (I) as defined above as flavor modulating compounds.

In a further embodiment the flavor modulating compounds according to the present invention are particularly useful in a wide variety of flavor compositions and consumer products including savoury food, non-savoury food, such as dairy, beverages and confectionery.

For example, a flavor composition comprises at least 0.01 wt. %, or at least 0.1 wt %, or at least 0.5 wt % of flavoring substances based on the total weight of the composition, and between 0.001 and 80 wt % of the flavor modulating compound(s) according to the present invention, preferably between 0.01 and 50 wt. %, more preferably between 0.01 and 20 wt. % of the flavor modulating compound(s) based on the total weight of the composition.

In a typical flavor composition, the flavor modulating compounds and flavoring substances are employed in a weight ratio within the range of 10:1 to 1:150, preferably in a weight ratio of 5:1 to 1:100.

The flavor compositions comprising the flavor modulating compound may suitably be prepared in the form of a liquid, a paste or a powder. For example, the flavor composition is a free flowing powder.

Typical examples of flavor compositions include savoury flavorings, sour/acid flavorings and others.

For example, the flavor composition is a salt reducing flavor composition.

The flavor modulating compounds of the invention can be used in flavor compositions in conjunction with one or more ingredients or excipients conventionally used in flavor compositions beside flavoring substances, for example carrier materials and other auxiliary agents commonly used in the art. Suitable excipients for flavor compositions are well known in the art and include, for example, without limitation, solvents (including water, alcohol, ethanol, oils, fats, vegetable oil, and miglyol), binders, diluents, disintegrating agents, lubricants, flavor agents, coloring agents, preservatives, antioxidants, emulsifiers, stabilisers, flavor-enhancers, anti-caking agents, and the like.

Examples of such carriers or diluents for flavor compositions may be found in for example, “Perfume and Flavour Materials of Natural Origin”, S. Arctander, Ed., Elizabeth, N.J., 1960; in “Perfume and Flavour Chemicals”, S. Arctander, Ed., Vol. I & II, Allured Publishing Corporation, Carol Stream, USA, 1994; in “Flavourings”, E. Ziegler and H. Ziegler (ed.), Wiley-VCH Weinheim, 1998, and “CTFA Cosmetic Ingredient Handbook”, J. M. Nikitakis (ed.), 1st ed., The Cosmetic, Toiletry and Fragrance Association, Inc., Washington, 1988.

Other suitable and desirable ingredients of flavor compositions are described in standard texts, such as “Handbook of Industrial Chemical Additives”, ed. M. and I. Ash, 2nd Ed., (Synapse 2000).

In another aspect of the present invention, there is further provided a consumer product comprising at least one compound of formula (I) or a flavor composition comprising one or more compounds of formula (I) and a product base.

By “product base” is meant the combination of all the usual art-recognized ingredients required for the particular consumable composition.

In another aspect of the present invention, there is provided a consumer product selected from the group consisting of foodstuffs and beverages, said consumer product comprising at least 10 ppm, preferably at least 50 ppm, more preferably at least 100 ppm or 200 ppm of one or more flavor modulating compounds according to formula (I) and/or edible salts thereof.

For example, said product contains at least 0.001 wt. %, more preferably at least 0.005 wt. %, even more preferably at least 0.01 wt. %, most preferably at least 0.02 wt. % of the one or more flavor modulating compounds. Typically, the aforementioned products will contain the flavor modulating compounds in a concentration of not more than 0.05 wt. %, preferably of not more than 0.025 wt. %.

For example, the consumer product has a reduced salt content.

Typical examples of foodstuffs according to the present invention include soups, sauces, stocks, bouillons, cheese products, dressings, seasonings, margarines, noodles and beverages.

The flavor modulating compounds according to the present invention can be applied advantageously to impart desirable taste attributes to the aforementioned products. In addition, the present flavor modulating compounds are capable of modulating the taste impact of other flavor ingredients contained within these same products, thereby improving the overall flavor quality of these products.

In another aspect of the present invention, there is provided the use of the compounds of formula (I) as flavor modulating compounds, wherein the compounds can be used in pure form or in diluted form, provided in liquid or in solid form.

In another aspect of the present invention, there is provided a method to confer, enhance, improve or modify the flavor properties of a flavor composition or a consumer product comprising adding to said composition or consumer product at least one flavor modulating compound, which is the compound of formula (I) or an edible salt thereof. For example, the flavor modulating compound is added in an amount of at least 0.001 wt. %, preferably of at least 0.01 wt. %.

The preparation of the compounds of the present invention can be carried out by methods known in the art. For example, the compounds can be obtained by chemical or enzymatic reactions.

The invention is now further described with reference to the following non-limiting examples. These examples are for the purpose of illustration only and it is understood that variations and modifications can be made by one skilled in the art.

### EXAMPLES

### General

1H-imidazole (CAS-No. 288-32-4), 4-methyl-1H-imidazole (CAS-No. 822-36-6), (2E)-3-(1H-imidazol-4-yl)prop-2-enoic acid (3-(1H-imidazol-4-yl)acrylic acid or urocanic acid, CAS-No. 104-98-3), 2-(1H-imidazol-4-yl)acetic acid (CAS-No. 645-65-8) and benzimidazole (CAS-No. 51-17-2) are commercially available, for example from Sigma-Aldrich.

In the following examples the concentrations are given in % by weight.

### Example 1: Taste

1H-imidazole has been tasted at different concentrations in water by a sensory panel.

While no effect was noticed up to a concentration level of 40 ppm, a subtle salty taste could be detected at a concentration of 50 ppm. At the concentration level of 100 ppm the compound has a weak salty taste along with some astringency and acidity. The saltiness at the concentration level of 100 ppm of 1H-imidazole is comparable to 0.05% NaCl in water, however, the saltiness is flat, not matching all aspects of NaCl. At the concentration level of 1000 ppm there is still perceived a weak salty taste, but there is mainly a bitter taste.

### Example 2: Salt Enhancement

Two aqueous solutions have been prepared:
A) 0.3% NaCl, and
B) 0.3% NaCl and 100 ppm of 1H-imidazole.

The solutions were tasted by a sensory panel. Solution A was described as “salty”. Solution B was described as clearly more salty with a mineralic note, low acidity, some astringency and freshness.

### Example 3: Umami Enhancement

Two aqueous solutions have been prepared:
A) 0.5% NaCl, 0.03% MSG, 0.007% Ribotides, and
B) 0.5% NaCl, 0.03% MSG, 0.007% Ribotides and 100 ppm of 1H-imidazole.

The solutions were tasted by a sensory panel. Solution A is a model solution for savoury taste, containing MSG (monosodium glutamate) and Ribotides (IMP/GMP, 50/50 mixture) as savoury taste enhancer. Solution B was described as having a strong boost of saltiness and umami in comparison to solution A.

### Example 4: Bitter Masking

Two aqueous solutions have been prepared:
A) 0.3% KCl, and
B) 0.3% KCl and 70 ppm of 1H-imidazole.

The solutions were tasted by a sensory panel. Solution B was described as less metallic and more salty in comparison to solution A.

### Example 5: Effect on Broth

A model broth base, comprising 0.3% of NaCl was compared with a sample further comprising 100 ppm of 1H-imidazole.

The solutions were tasted by a sensory panel. The sample additionally comprising 1H-imidazole was described as more mineral and salty as well as more umami in comparison to the model broth base.

### Example 6: Effect on Cheese Sauce

The effect of 1H-imidazole on a commercially available cheese sauce was explored.

Therefore, a cheese sauce has been compared by a sensory panel with a sample of the sauce further comprising 70 ppm of 1H-imidazole.

The sauce additionally comprising 1H-imidazole was described as more mineral and salty.

### Example 7: Combination With Other Taste Modulating Compounds Combinations of taste modulating compounds have been added to a 0.3% NaCl solution in water.

A) 100 ppm of 1H-imidazole and 50 ppm of N-lactoyl ethanolamine;
B) 100 ppm of 1H-imidazole and 0.04 ppm of N-oleoylmethionine;
C) 100 ppm of 1H-imidazole and 50 ppm of ((2E)-3-(1H-imidazol-4-yl)-N-[2-(1H-imidazol-4-yl)ethyl]prop-2-enamide); and
D) 100 ppm of 1H-imidazole, 50 ppm of N-lactoyl ethanolamine, 0.04 ppm of N-oleoylmethionine, and 50 ppm of ((2E)-3-(1H-imidazol-4-yl)-N-[2-(1H-imidazol-4-yl)ethyl]prop-2-enamide).

The samples were tasted by a sensory panel and rated against a solution of 100 ppm of 1H-imidazole in 0.3% NaCl solution.

Sample A was described to show a more salty and mineral taste.

Sample B was perceived as even more salty.

Sample C was having a boosted saltiness.

Sample D was performing best with regard to salty taste.

### Example 8: Effect on Potato Chips

Potato chips with 1.5% salt have been tasted by a sensory panel with and without 1H-imidazole.

The potato chips comprising 70 ppm of 1H-imidazole had a higher salty impact and a lingering effect in comparison to the potato chips without 1H-imidazole.

### Example 9: Effect on Mayonnaise

Samples of commercially available mayonnaise with and without addition of 1H-imidazole have been compared by a sensory panel.

In comparison to the pure mayonnaise, the sample comprising 70 ppm of 1H-imidazole was described as clearly more salty and had a stronger acetic acid character.

### Example 10: Effect on Corn Curls

Corn curls with cheese flavor with and without addition of 1H-imidazole have been compared by a sensory panel.

The taste of corn curls with added 100 ppm of 1H-imidazole was described as saltier, and the rich profile was enhanced in comparison to the curls without 1H-imidazole.

### Example 11: Effect on Vegan Burger

Soy based vegan burgers with and without 1H-imidazole have been tasted by a sensory panel.

The burger with 70 ppm of 1H-imidazole is described as being more salty in comparison to the version without, which holds for the initial peak of salty taste as well as the last phase of the salt perception.

### Example 12: Salt Enhancement

Two aqueous solutions have been prepared:
A) 0.5% NaCl, and
B) 0.5% NaCl and 50 of ppm of 4-methyl-1H-imidazole.

The solutions were tasted by a sensory panel. Solution A was described as “salty”. Solution B was described as more salty in comparison to solution A.

### Example 13: Salt Enhancement

Two aqueous solutions have been prepared:
A) 0.5% NaCl, and
B) 0.5% NaCl and 50 ppm of (2E)-3-(1H-imidazol-4-yl)prop-2-enoic acid (urocanic acid).

The solutions were tasted by a sensory panel. Solution A was described as “salty”. Solution B was described as more salty in comparison to solution A.

### Example 14: Taste

2-(1H-imidazol-4-yl)acetic acid and benzimidazole have been tasted at different concentrations in water by a sensory panel.

A subtle salty and sour taste could be detected at a concentration of 30 ppm for benzimidazole.

At the concentration level of 70 ppm the compound has a weak salty taste along with some sour background.

For 2-(1H-imidazol-4-yl)acetic acid, a subtle salty and mineral taste could be detected at a concentration of 30 ppm. At the concentration level of 90 ppm the compound has a weak salty, mineralic taste with a slightly sour note.

The saltiness at the concentration level of 70 ppm of both compounds is comparable to 0.05% NaCl in water.

### Example 15: Salt Enhancement

The following aqueous solutions have been prepared:
A) 0.3% NaCl,
B) 0.3% NaCl and 90 ppm of 2-(1H-imidazol-4-yl)acetic acid, and
C) 0.3% NaCl and 80 ppm of benzimidazole.
The solutions were tasted by a sensory panel. Solution A was described as “salty”. Solution B was described as clearly more salty with a minearlic note, and solution C was described as clearly more salty with a sour fresh background.

### Example 16: Bitter Masking

The following aqueous solutions have been prepared:
A) 0.3% KCl, and
B) 0.3% KCl and 100 ppm of 2-(1H-imidazol-4-yl)acetic acid, and
C) 0.3% KCl and 100 ppm of benzimidazole.

The solutions were tasted by a sensory panel. Solutions B and C were described as less bitter, less metallic and more salty in comparison to solution A. Both compounds are good KCl maskers. Solution B was preferred over solution C.

### Example 17: Effect on Broth

A model broth base, comprising 0.3% of NaCl was compared with a sample further comprising 70 ppm of 2-(1H-imidazol-4-yl)acetic acid, and 100 ppm of benzimidazole, respectively.

The solutions were tasted by a sensory panel. The samples additionally comprising 2-(1H-imidazol-4-yl)acetic acid or benzimidazole were described as more mineral and salty in comparison to the model broth base. The solution comprising benzimidazole was preferred.

### Example 18: Effect on Cheese Sauce

The effect of 2-(1H-imidazol-4-yl)acetic acid on a commercially available cheese sauce was explored. Therefore, a cheese sauce has been compared by a sensory panel with a sample of the sauce further comprising 50 ppm of 2-(1H-imidazol-4-yl)acetic acid.

The sauce additionally comprising 2-(1H-imidazol-4-yl)acetic acid was preferred, having more saltiness and umami character.

### Example 19: Combination With Other Taste Modulating Compounds

Combinations of taste modulating compounds have been added to a 0.3% NaCl solution in water.
A) 50 ppm of 2-(1H-imidazol-4-yl)acetic acid and 50 ppm of A-lactoyl ethanolamine;
B) 50 ppm of 2-(1H-imidazol-4-yl)acetic acid and 0.04 ppm of N-oleoylmethionine;
C) 50 ppm of 2-(1H-imidazol-4-yl)acetic acid, 50 ppm of N-lactoyl ethanolamine and 0.04 ppm of N-oleoylmethionine,
D) 50 ppm of 2-(1H-imidazol-4-yl)acetic acid, 50 ppm of A-lactoyl ethanolamine, 0.04 ppm of N-oleoylmethionine, and 50 ppm of ((2E)-3-(1H-imidazol-4-yl)-N-[2-(1H-imidazol-4-yl)ethyl]prop-2-enamide),
E) 50 ppm of benzimidazole and 50 ppm of N-lactoyl ethanolamine;
F) 50 ppm of benzimidazole and 0.04 ppm of N-oleoylmethionine;
G) 50 ppm of benzimidazole, 50 ppm of N-lactoyl ethanolamine and 0.04 ppm of N-oleoylmethionine,
H) 50 ppm of benzimidazole, 50 ppm of N-lactoyl ethanolamine, 0.04 ppm of N-oleoylmethionine, and 50 ppm of ((2E)-3-(1H-imidazol-4-yl)-N-[2-(1H-imidazol-4-yl)ethyl]prop-2-enamide),

The samples were tasted by a sensory panel and rated against a solution of 50 ppm of the respective imidazole derivative in 0.3% NaCl solution.

Sample A was described to have an enhanced saltiness effect and lingering mineralized character.

Sample B was perceived as also saltier than the blend of 2-(1H-imidazol-4-yl)acetic acid and salt.

Sample C was having a good salt enhancement with a rounded balance effect.

Sample D was performing best with regard to a balanced and salty taste.

Sample E was described to have an enhanced saltiness effect and lingering mineralized character. The effect was preferred over the one of sample A.

Sample F was perceived as similar to the blend of benzimidazole and salt.

Sample G was having a good salt enhancement with a rounded balance effect.

Sample H was perceived as similar to sample G.

### Example 20: Effect on Mayonnaise

Samples of commercially available mayonnaise with addition of 2-(1H-imidazol-4-yl)acetic acid or benzimidazole and without have been compared by a sensory panel.

In comparison to the pure mayonnaise, the sample comprising 70 ppm of 2-(1H-imidazol-4-yl)acetic acid or benzimidazole were described as clearly more salty with a less sour impression.

### Example 21: Effect on Corn Curls

Corn curls with cheese flavor with addition of 2-(1H-imidazol-4-yl)acetic acid or benzimidazole and without have been compared by a sensory panel.

The taste of corn curls with added 150 ppm of 2-(1H-imidazol-4-yl)acetic acid or benzimidazole was described as saltier, and the rich profile was enhanced in comparison to the curls without the additional compound.

### Example 22: Effect on Ketchup

Samples of commercially available ketchup with and without addition of 2-(1H-imidazol-4-yl)acetic acid or benzimidazole have been compared by a sensory panel.

In comparison to the pure ketchup, the sample comprising 100 ppm of 2-(1H-imidazol-4-yl)acetic acid was described as clearly more salty, sour lingering and less sweet. The sample comprising 70 ppm of benzimidazole was also described as clearly more salty.

1. A method of utilizing one or more compounds of formula (I) 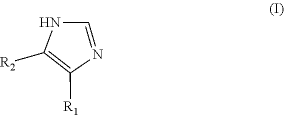
and edible salts thereof, wherein
R₁ and R₂ is independently selected from the group consisting of H, linear C1-C18 hydrocarbon groups, and branched C1-C18 hydrocarbon groups, wherein the C1-C18 hydrocarbon groups bear up to 3 O atoms, and/or bearing up to one double bond, and/or bearing up to one ring,
or wherein R₁ and R₂ form together with the carbon atoms they are attached to an aromatic six membered hydrocarbon ring,
as a flavor modulating compound, wherein the method comprises adding the one or more compounds of formula (I) to a flavor composition or a consumer product.

2. The use method according to claim 1, wherein R₁ and R₂ are independently selected from the group consisting of H, Me, Et, n-Pr, iso-Pr, n-Bu, iso-Bu, sec-Bu, tert-Bu, hexadecyl, octadecyl, ethenyl, propenyl, octadecenyl, formyl, 2-oxoethyl, 3-oxopropyl, carboxyl, carboxymethyl, carboxy(hydroxy)methyl, carboxycarbonyl, 2-carboxyethyl, 2-carboxyvinyl and 3-carboxypropyl, or wherein R₁ and R₂ form together with the carbon atoms they are attached to an aromatic six membered ring.

3. The method according to claim 1, wherein the compound of formula (I) is selected from the group consisting of 1H-imidazole, 4-methyl-1H-imidazole, 4-ethyl-1H-imidazole, 4-propyl-1H-imidazole, 4-butyl-1H-imidazole, 4-hexadecyl-1H-imidazole, 4-octadecyl-1H-imidazole, 4-ethenyl-1H-imidazole, 4-propenyl-1H-imidazole, 4-octadecenyl-1H-imidazole, 1H-imidazole-4-carbaldehyde, 2-(1H-imidazol-4-yl)acetaldehyde, 3-(1H-imidazol-4-yl)propanal, 1H-imidazole-4-carboxylic acid, 2-(1H-imidazol-4-yl)acetic acid, 2-hydroxy-2-(1H-imidazol-4-yl)acetic acid, 2-(1H-imidazol-4-yl)-2-oxoacetic acid, 3-(1H-imidazol-4-yl)propanoic acid, 3-(1H-imidazol-4-yl)acrylic acid, 4-(1H-imidazol-4-yl)butanoic acid, and benzimidazole.

4. The method according to claim 1, wherein the compound of formula (I) is used as a salt enhancing compound.

5. The method according to claim 1, wherein the compound of formula (I) is used as an acidic taste impacting compound and/or bitter masking compound and/or umami taste enhancing compound.

6. A flavour composition comprising the compound of formula (I) as defined in claim 1.

7. The flavour composition according to claim 6 comprising the compound of formula (I) in about 0.001 and 80 wt % of the flavor composition.

8. A consumer product comprising the compound of formula (I) as defined in claim 1 and a consumer product base.

9. The consumer product according to claim 8 comprising the compound of formula (I) in about 0.001 to 0.05 wt % of the consumer product.

10. The consumer product according to claim 8, wherein the consumer product is selected from foodstuff and beverages.

11. A method to confer, enhance, improve or modify the flavor properties of a flavor composition or a consumer product, which method comprises adding to said composition or consumer product at least one compound of formula (I) as defined in claim 1.

12. The method according to claim 11, wherein the flavor property is saltiness.

13. The method according to claim 12, wherein the flavor property is acidic taste, bitterness and/or umami taste.

14. The method according to claim 1, wherein the compound of formula (I) is selected from the group consisting of 2-(1H-imidazol-4-yl)acetic acid and 3-(1H-imidazol-4-yl)acrylic acid.

15. A consumer product comprising the flavour composition according to claim 6 and a consumer product base.
